(19) United States
(12) Patent Application Publication
(10) Pub. No.: US 2009/0311367 A1
(43) Pub. Date: Dec. 17, 2009

(54) Dietary Supplement

(76) Inventor: Stephen C. Perry, Norwood, MA (US)

Correspondence Address: James David Johnson, P.A., 401 East Las Olas Boulevard, Suite 130-290, Fort Lauderdale, FL, 33301, US

(21) Appl. No.: 12/485,451

(22) Filed: Jun. 16, 2009

Related U.S. Application Data
(60) Provisional application No. 61/073,143, filed on Jun. 17, 2008.

(51) Int. Cl. A23K 1/165; A23L 1/236; A23D 9/013

(52) U.S. Cl. 426/2; 426/601; 426/548; 426/64

(57) ABSTRACT

Compositions and methods for suppressing appetite and inducing weight loss in humans and other mammals contain fatty acids. The fatty acids of the compositions include long-chain fatty acids such as oleic, lauric, and linoleic acids. The compositions may also contain medium-chain triglycerides, natural sweeteners, and other plant extracts. The compositions can also contain a linear aminopolysaccharide and lipoprotein lipase to reduce blood serum levels of low-density lipoproteins and triglycerides.

### CROSS-REFERENCE TO RELATED APPLICATION

This application claims the priority from U.S. provisional patent application Ser. No. 61/073,143 filed Jun. 17, 2008. The foregoing application is incorporated in its entirety herein by reference.

### FIELD OF THE INVENTION

The invention relates to compositions, methods and systems for inducing weight loss. More particularly, the invention relates to compositions, methods and systems for suppressing a mammal's appetite to reduce caloric intake so as to cause weight loss.

### BACKGROUND

Obesity and being overweight have been linked to numerous adverse health conditions including diabetes, heart disease, stroke, high blood pressure, various types of cancer, and osteoarthritis. As the public has become more aware of the negative health consequences associated with being overweight, individuals have turned to dieting, exercise, drugs, and surgery as solutions to their weight loss needs. Dietary supplements and pharmaceutical products intended to induce weight loss often include artificial chemicals that may negatively affect the body. Likewise, surgery, such as bariatric surgery which reduces the size of the stomach, and fasting also entail great health risks to an individual seeking to lose weight. The enormity of these health risks may not be worth the potential benefit sought in utilizing those methods of weight loss. While exercise is an excellent means by which to control an individual's weight, often obese individuals and people experiencing undesired weight gain require more than just simple exercise to achieve their weight loss goals. Safe and natural compositions are needed to assist these individuals with weight loss while reducing the risks of negative health effects that can occur through pharmaceutical use, surgery, and fasting.

Some dietary supplements have been known to contain fatty acids, which are aliphatic monocarboxylic acids derived from, or contained in esterified form, in an animal or vegetable fat, oil or wax. Natural fatty acids commonly have a chain of 4 to 28 carbons that is usually unbranched and even-numbered, which may be saturated or unsaturated.

The human body can produce all but two of the fatty acids it needs. These two fatty acids, linoleic acid (LA acid) and alpha-linolenic acid (ALA), are widely distributed in plant oils. Because linoleic acid and alpha-linolenic acid cannot be produced by the body from other substrates, these essential fatty acids must be obtained from foods. Mammals lack the ability to introduce double bonds in fatty acids beyond carbons 9 and 10. Hence, linoleic acid and alpha-linolenic acid are essential fatty acids for humans. Other long-chain fatty acids are generated by the body during the hydrolysis of dietary fat.

Short- and medium-chain fatty acids are absorbed directly into the blood via intestinal capillaries and travel through the portal vein as do other absorbed nutrients. However, long-chain fatty acids are too large to be directly enter into the tiny intestinal capillaries. Instead, long-chain fatty acids are absorbed into the fatty walls of the intestinal villi and reassembled into triglycerides. Fat metabolism and storage influence long-term control of energy balance in humans.

Understanding consumers' eating behavior has always been an important factor for manufacturers of dietary supplements and low calorie foods used for weight loss management. Meeting consumers' expectations for healthier products that can perform as expected in weight loss management regimes can prove difficult using conventional weight loss methods and products. Satiety is now becoming a focus in the context of health, wellness, and weight loss management. While hunger and appetite represent the physiological and psychological need and desire to eat, respectively, satiety describes the opposite end of the hunger/appetite spectrum representing both the physiological and psychological feeling of fullness. Researchers have discovered that satiety is promoted not only by the quantity of food consumed but also by that food's macronutrient content (i.e., protein, carbohydrates, fats) and ingredient composition as well.

Unlike satiation, which refers to the point at which a meal (or the food that is eaten at one sitting) satisfies hunger, satiety relates to the effects of a meal after it has ended. The metabolic mechanisms involved in satiety range from digestion-related processes, such as gastric distention and emptying, to more complex hormonal effects. Thus, satiation develops during the course of eating and satiety starts at the end of one meal and lasts until the next. Conventional natural dietary products and methods do not affect or control satiety to provide any measurable weight loss management benefit.

The “ileal brake,” a fat-induced inhibition of food intake, is the primary inhibitory feedback mechanism serving to control the movement of consumed food through the gastrointestinal tract although other “brakes” are believed to also play a role in managing the movement of ingested food through the alimentary canal. This distal gut inhibitory feedback system slows the speed of gastrointestinal transit in response to food intake. Nutrients, and fatty acids in particular, are believed to be the primary activators of the ileal brake. This inhibitory feedback mechanism regulates the speed of luminal peristalsis in the gastrointestinal tract to maximize the absorption of nutrients, and thus, creates a sense of satiety. Neurohormonal factors are involved in producing the ileal brake and other brake effects in the gastrointestinal tract of humans. Researchers have discovered that when the normal movement of ingested food through the digestive tract is disrupted, malnutrition and diarrhea may occur due to the malabsorption of nutrients. While such nutrient-triggered digestion brakes have been studied with respect to treatments for diarrhea, malnutrition, and drug malabsorption, the effects of the ileal brake have not been used successfully by conventional all-natural products and methods for weight loss management.

Fat, protein, and carbohydrates are triggers of the ileal brake. As the stomach empties, nutrients spread uniformly down the length of the gut. End products of nutrient digestion trigger the ileal brake. For example, liquid fat floats in the stomach and may be delayed in its presentation to the ileum, thereby producing later potent and prolonged inhibition of gastrointestinal transit of a meal. To trigger the fat-induced ileal brake, fat must be sensed by the distal small intestine and intestinal transit must be slowed by the proximal small intestine. The long-chain fatty acids generated during dietary fat hydrolysis assist in causing the ileal brake effect. The signal for causing the ileal brake effect is believed to be mediated by cholecystokinin (CCK or pancreozymin), a hunger-suppressing peptide hormone produced by the gastrointestinal system that is responsible for stimulating the digestion of fat and protein. CCK is synthesized by I-cells found in the small intestine's mucosal epithelium. CCK is secreted in the duodenum and causes the release of bile and digestive enzymes by the gallbladder and pancreas. Dietary fat is believed to induce a physiological response at a preabsorptive site to decrease food intake and that this effect is indirectly mediated by the release of CCK. Long-chain fatty acids in the form of oleic acid and medium-chain fatty acids in the form of caprylic acid have been used by researchers to assess the importance of chain length. The chain length of free fatty acids is also believed to be crucial for initiating feedback inhibition of food intake, and the feedback response on food intake that is induced by long-chain fatty acids may be mediated by CCK using the specific CCK-A receptor antagonist loxiglumide (LOX). Conventional dietary methods and products have not yet been capable of triggering the fat-induced ileal brake to achieve a weight loss management benefit for humans or other mammals without the use of pharmaceuticals.

In humans and other mammals, adipose tissue is composed of energy storing adipocytes, or fat cells. Adipocyte formation, also known as adipogenesis, occurs when pre-adipocyte cells undergo shape changes and in the amount and distribution of fat content during a series of cellular stages. Various genes are expressed at each stage of adipogenesis and can be used as markers for the different stages of adipogenesis. On the cellular level, obesity is caused by either adipocyte hyperplasia or hypertrophy. In the case of adipocyte hyperplasia, the number of fat cells in the body increases. In the case of adipocyte hypertrophy, existing fat cells in the body become enlarged and store greater amounts of fat.

Adipocyte hypertrophy is often connected to adult-onset obesity. Gene transcription factors are responsible for controlling the size of adipocytes. For example, enlarged adipocytes often exhibit reduced expression of the hormone adiponectin, which plays a role in the body's sensitivity to insulin.

Two enzymes, lipoprotein lipase and glycerol-3-phosphate dehydrogenase (GDPH), are indicators of the conversion of preadipocyte cells into adipocytes. These two enzymes have also been linked to the accumulation of fat within adipocytes. The human body utilizes glycerol-3-phosphate dehydrogenase to synthesize triglycerides from glucose. The production of these enzymes may be suppressed to decrease the amount of glucose in the bloodstream that is converted into fatty acids.

Another hormone that is important in weight loss and appetite control is leptin. Leptin triggers appetite controls in the brain that signal to the brain when a person has consumed a sufficient number of calories or amount of food so that the person can stop eating. Leptin can also induce a cellular process in which fat stored within fat cells is broken down. As a person ages, the person's fat cells and the appetite control center of the person's brain may become resistant to the weight regulatory effects of leptin resulting in a lesser degree of appetite suppression and weight gain. A pro-inflammatory compound, C-reactive protein (CRP), which is produced by fat cells, is partially responsible for the cellular leptin resistance that develops with increased age.

A need exists for a dietary supplement that can function as an appetite suppressant and weight control regulator. A need also exists for a dietary supplement that can decrease the body's blood serum levels of low-density lipoproteins and triglycerides while increasing the blood serum levels of high-density lipoproteins.

### SUMMARY

The invention relates to fatty acid compositions that suppress the appetite of a human or other mammal to induce weight loss. The compositions are produced from a combination of all-natural ingredients including fatty acids derived from plant oils, water, and natural flavoring. The compositions include, primarily, lauric, linoleic, and oleic fatty acids but may also include other fatty acids, oils, and botanical extracts that suppress the appetite, reduce caloric intake, and promote weight loss.

The composition may also include linear aminopolysaccharide and lipoprotein lipase, which when ingested, have the effect of reducing blood serum levels of low-density lipoproteins and triglycerides. The inhibitory effects of linear aminopolysaccharide and lipoprotein lipase are described in U.S. Pat. No. 5,942,500, issued to Perry, Aug. 24, 1999. which is incorporated by reference herein it its entirety.

Ingestion of one or more of the all-natural, fatty acid-containing compositions (referred to henceforth in the singular as “a composition” or “the composition”) by humans, dogs, and other mammals creates a sense of satiety, which is also known as the “ileal brake.” Consumption of the composition causes a corresponding decrease in food consumption, early satiation, and a delay in gastric emptying. These beneficial weight loss management effects are accompanied by an increase in plasma CCK levels, which further enhances satiety by suppressing hunger.

When ingested, the composition can also serve to lower the human body's levels (e.g., presence in the blood) of low-density lipoproteins or LDL (bad cholesterol) and triglycerides while increasing the levels of high-density lipoproteins or HDL (good cholesterol). By suppressing the user's appetite and providing a sense of satiety, the composition assists in reducing the user's body weight and amount of body fat.

The composition provides a dietary supplement containing fatty acids that can increase the body's levels of adiponectin and leptin and to reduce the levels and inhibit the production of CRP and glycerol-3-phosphate dehydrogenase. Ingestion of the composition also inhibits production of the enzyme amylase, which plays an important role in the digestion of carbohydrates. By inhibiting amylase production, the fatty acids of the composition can decrease the amount of ingested starches that will be converted to and absorbed as glucose (sugar).

The composition is advantageous in that the ingredients are all-natural and cause no negative health effects upon individuals ingesting the product. The composition is also beneficial because it can be used in addition to other weight loss programs such as dieting, exercise, and pharmaceutical use without the risk of adverse side effects. Another advantage of the composition is its ability to suppress the appetite of mammals, including but not limited to humans and dogs, by stimulating the body's release of the hunger-suppressing hormones cholecystokinin (CCK) and glucagon-like peptide (GLP1). These hormones assist the body in digesting fats more efficiently and also trigger a sensation of satiation in the brain that decreases the desire to eat. Because the desire to eat is decreased, caloric intake is reduced in individuals taking the composition thereby resulting in weight loss.

Still another advantage of the composition and the method of using the composition for appetite suppression and weight loss is that the preferred embodiment of the composition does not include any nervous system stimulants, which can present numerous and dangerous health risks to some individuals. The composition is also advantageous in that it promotes thermogenesis to increase the body's metabolism thereby providing a quick source of energy to the user. As a source of energy, the composition increases the user's resistance to fatigue and stress; increases, restores, and sustains energy levels; increases stamina; alleviates mental fatigue and sharpens mental clarity and concentration; and assists the user in controlling stress-induced appetite and stress-related overeating. By inducing weight loss, the composition also helps the user to attain better heart health.

Yet another advantage of the composition and method of using the composition is that ingestion of the composition by a human or other mammal results in decreased food consumption, early satiation, and a delay in gastric emptying, all of which serve to limit caloric intake thereby assisting in weight control and weight loss.

Accordingly, the invention features a composition for suppressing a mammal's appetite that can include a fatty acid complex and a sweetener. The fatty acid complex can include fatty acids featuring carbon chain lengths of 12 to 22.

In another aspect, the invention can feature the fatty acid complex including at least two fatty acids selected from the group that includes alpha-linoleic acid, arachidic acid, behenic acid, capric acid, caprylic acid, eicosanic acid, erucic acid, lauric acid, linoleic acid, margaric acid, margaroleic acid, myristic acid, palmitic acid, palmitoleic acid, and stearic acid. In another aspect, the invention can feature the fatty acid complex including lauric acid, linoleic acid, and oleic acid.

In another aspect, the invention can feature the fatty acid complex further including palmitoleic acid.

In another aspect, the invention can feature the sweetener being a non-caloric sweetener.

In another aspect, the invention can feature the non-caloric sweetener including at least one sweetener selected from the group that includes acesulfame potassium, stevia, lo han quo (Mormodica grosvenorii), mabinlang (Capparis masaikai), sucralose, thaumatin (Thaumatococcus daniellii), and brazzein (Pentadiplandra brazzana).

In another aspect, the invention can feature the sweetener being mixed with a bulking agent.

In another aspect, the invention can feature the bulking agent being selected from the group that includes erythritol, gluco-mannitol, and gluco-sorbitol.

In another aspect, the invention can feature the fatty acid complex including linoleic acid, oleic acid, and MCT oil.

In another aspect, the invention can feature the composition further including an extract of ashwagandha (Withania somnifera).

In another aspect, the invention can feature the composition further including a mixture of a linear aminopolysaccharide and lipoprotein lipase.

In another aspect, the invention can feature the linear aminopolysaccharide including recurring units of (1-4)-linked 2-amino-2-deoxy-β-D-glucopyranose.

In another aspect, the invention can feature the composition further including at least one ingredient selected from the group that includes citric acid; calcium polyascorbate; 2-hydroxy-1,2,3-propanetricarboxylic acid; and lovastatin.

In another aspect, the invention can feature the fatty acid complex including myristic acid, lauric acid, linolenic acid, and palmitic acid.

In another aspect, the invention can feature the composition further including an extract of Irvingia gabonensis as a source of myristic acid, lauric acid, linolenic acid, and palmitic acid.

In another aspect, the invention can feature the composition including a linear aminopolysaccharide.

In another aspect, the invention can feature the composition further including a fruit juice concentrate, water, xanthan gum, soy lecithin, sodium benzoate, potassium sorbate, a flavoring agent, sucralose, and citric acid.

The invention also features a composition for suppressing a mammal's appetite and reducing blood serum levels of low-density lipoproteins and triglycerides. The composition includes a fatty acid complex, an aminopolysaccharide, and a sweetener.

A method of the invention includes the steps (a) preparing a composition that can include a fatty acid complex featuring fatty acids having carbon chain lengths of 12 to 22 and a sweetener; and (b) permitting a mammal to ingest the composition at regular intervals. The method can be used to suppress a mammal's appetite.

Another method of the invention can be used to affect changes in blood serum levels of low-density lipoproteins, triglycerides, and high-density lipoproteins. The method can include the steps of: (a) preparing a composition that can include a fatty acid complex featuring fatty acids having carbon chain lengths of 12 to 22, a sweetener, and a mixture of linear aminopolysaccharide and lipoprotein lipase; and (b) permitting a mammal to ingest the composition at regular intervals.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### DETAILED DESCRIPTION

The invention provides a composition for suppressing the appetite of a human so as to induce weight loss. The composition contains primarily fatty acid compounds with carbon chain lengths from 12 to 22, and in preferred embodiments, with carbon chain lengths from 16 to 20, and in the most preferred embodiments with carbon chain lengths of 18 with 1 to 3 double bonds. The mixtures of these all-natural, plant-based fatty acids form a fatty acid complex that includes lauric acid, linoleic acid, and oleic acid. In one embodiment, the fatty acid complex may also contain palmitoleic acid. In another embodiment, the fatty acid complex may also contain one or more of palmitoleic acid, caprylic acid, capric acid, myristic acid, palmitic acid, margaric acid, margaroleic acid, stearic acid, alpha-linoleic acid, arachidic acid, eicosanic acid, behenic acid, and erucic acid.

In an exemplary embodiment, the composition can also contain an extract of Irvingia gabonensis as a source of fatty acids including, but not limited to, myristic acid, lauric acid, linolenic acid, and palmitic acid.

In one embodiment, the composition may contain a medium-chain triglycerides (MCT) oil in place of the lauric acid. The MCT oil includes a blend of primarily caprylic acid and capric acid and a small amount of caproic acid and lauric acid. The acids forming the MCT oil blend are esterified to a glycerol backbone. The MCT oil, linoleic acid, and oleic acid can be obtained from any suitable source including but not limited to coconut oil, sesame seed oil, peanut oil, palm oil, almond oil, canola oil, and sea buckthorn fruit oil (Hippophae rhamnoides). In one embodiment, the MCT oil, and oleic acid are derived from palm kernel oil. In an exemplary embodiment, sea buckthorn fruit oil is used as the source of oleic and linoleic acids.

The composition may further include one or more sweeteners. In an exemplary embodiment that is especially useful as a night-time appetite suppressant, the sweeteners are non-caloric sweeteners such as, for example, acesulfame potassium, stevia, lo ban quo (Mormodica grosvenorii), mabinlang (Capparis masaikai), sucralose, thaumatin (Thaumatococcus daniellii), and brazzein (Pentadiplandra brazzana). The non-caloric sweeteners can be mixed with a bulking agent such as, for example, erythritol, gluco-mannitol, and gluco-sorbitol, to provide the sweetener with the same or similar volume, texture, and appearance as sugar (sucrose).

In one embodiment, the composition may also include one or more botanical extracts such as, for example, extracts of ashwagandha (Withania somnifera).

In one embodiment, the composition can contain the ingredients in the following percentages: about 20% by weight lauric acid, about 10-50% by weight linoleic acid, about 10-60% by weight oleic acid, and about 0-60% by weight other long-chain fatty acids. In another embodiment, the composition can contain the ingredients in the following percentage ranges: about 10-30% by weight lauric acid, about 1-60% by weight linoleic acid, about 1-70% by weight oleic acid, and about 0-70% by weight other long-chain fatty acids.

In an exemplary embodiment, the composition can contain about 20% by weight MCT oil, about 15% by weight linoleic acid, about 40% by weight oleic acid, and about 25% by weight other long-chain fatty acids.

In another exemplary embodiment containing Irvingia gabonensis, the composition can contain about 51% by weight myristic acid, about 38% by weight lauric acid, about 7% by weight linolenic acid, and about 5% by weight palmitic acid.

In an alternate embodiment, to enhance the composition's LDL and triglyceride level reducing properties, the composition can include a cholesterol-reducing mixture of linear aminopolysaccharide and lipoprotein lipase. The linear aminopolysaccharide can include recurring units of (1-4)-linked 2-amino-2-deoxy-β-D-glucopyranose. The cholesterol-reducing mixture can feature about 60% by weight linear aminopolysaccharide and about 40% by weight lipoprotein lipase. In other embodiments, the cholesterol-reducing mixture can feature about 50-70% by weight linear aminopolysaccharide and about 30-50% by weight lipoprotein lipase.

In one embodiment, the cholesterol-reducing mixture may further include citric acid. The cholesterol-reducing mixture can feature about 63% by weight linear aminopolysaccharide, about 21% by weight lipoprotein lipase, and about 16% by weight citric acid.

In another embodiment, the cholesterol-reducing mixture can include calcium polyascorbate. In still another embodiment, the cholesterol-reducing mixture can include both citric acid and calcium polyascorbate.

In another embodiment, the cholesterol-reducing mixture can include 2-hydroxy-1,2,3-propanetricarboxylic acid. In still another embodiment, the cholesterol-reducing mixture can include 2-hydroxy-1,2,3-propanetricarboxylic acid and calcium polyascorbate. In still another embodiment, the cholesterol-reducing mixture can include 2-hydroxy-1,2,3-propanetricarboxylic acid and citric acid. In yet another embodiment, the cholesterol-reducing mixture can include 2-hydroxy-1,2,3-propanetricarboxylic acid, calcium polyascorbate, and citric acid.

In still another embodiment, the cholesterol-reducing mixture of the composition may include lovastatin.

In another aspect, the invention includes a method for extracting the oils/fatty acids from their plant sources. To obtain the fatty acids, the botanical source of the fatty acids can be processed without vigorous heat treatment. In another embodiment, concentrated oil from the botanical source is processed without vigorous heat treatment.

The botanical plant source of the fatty acids can be roots, stock, flowers, leaves, stems, fruits or seeds. In one step of the method, berries from a suitable plant source are crushed and seeds are separated from fruit pulp. Next, the seeds are cleaned and crushed. The crushed seeds and fruit pulp are then subjected to acceptable standard extraction processes such as, for example, solvent extraction, CO₂ extraction, cold pressed extraction, or expeller extraction. In an exemplary embodiment, expeller extraction is used to protect valuable phyto-chemicals in the crushed seeds and fruit pulp from exposure to chemicals or high heats. In another step of the method, fruit oil is extracted by centrifuge. The fruit oil is then exposed to an aqueous acidic solution that saponifies the oil and provides both saponified and non-saponifiable extracts.

### EXAMPLE

A 3 percent by weight aqueous citric acid solution was prepared by combining 81.7 grams of citric acid with 6 pounds of water. The aqueous citric acid solution was heated to 110 degrees Fahrenheit and circulated through 24 ounces of sea buckthorn berries and seed pulp for 15 minutes. The extraction yielded 1,184 grams of an aqueous extract and 142 grams of an unsaponifiable oil extract. Upon analysis, the aqueous extract was found to contain a total of 631.17 grams of saponifiable oils, indicating a greater than 96 percent recovery of the 648 grams of theoretically potential saponifiable oils initially present in the pulp.

In a method for suppressing the appetite of a human, the composition may be ingested approximately every eight hours at a dosage of 3 grams, or 1 teaspoon, of the fatty acid complex. In one embodiment, the composition may contain, in percentages by weight, 30% fatty acid complex, 25% berry juice concentrate, water (q.s. to 100%), 1% xanthan gum, 4% soy lecithin, 0.5% sodium benzoate, 0.3% potassium sorbate, 0.1% flavor, 0.02% sucralose, and an amount of citric acid added until the pH of the entire composition is approximately 4. The fatty acid complex of this embodiment of the composition can be composed of 10 parts linoleic acid, 45 parts oleic acid, and 45 parts lauric acid. This embodiment of the composition is an emulsion and may contain 3 grams of fatty acid complex per every 10 grams of the emulsion (equivalent to one serving).

The composition may be manufactured as a pill, caplet, tablet, liquid, powder, or gel. In one embodiment, the composition may be manufactured pre-mixed as part of a food or beverage. For example, in one embodiment, the composition may be mixed by a consumer or pre-mixed with a salad dressing to be eaten with a salad or other meal. In another embodiment, only the fatty acid complex of the composition is used as a base for a salad dressing. In still another embodiment, the composition, or only the fatty acid complex of the composition, may be used as a cooking oil in place of conventional cooking oils.

The composition has been tested on humans in four clinical trials (described below) to confirm its efficacy in suppressing the appetite and promoting weight loss. The test composition tested in the clinical trials below contained, in percentages by weight, 30% fatty acid complex, 25% berry juice concentrate, water (q.s. to 100%), 1% xanthan gum, 4% soy lecithin, 0.5% sodium benzoate, 0.3% potassium sorbate, 0.1% flavor, 0.02% sucralose, and an amount of citric acid added until the pH of the entire composition is approximately 4. The fatty acid complex of the test composition used in the clinical trials is composed of 10 parts linoleic acid, 45 parts oleic acid, and 45 parts lauric acid. The test composition used for the clinical trials was an emulsion and contained 3 grams of fatty acid complex per every 10 grams of the emulsion (one serving).

CLINICAL #1: Long-term effects of consumption of the test composition in relation to body-weight management.

Objective: To assess weight maintenance after weight loss by consumption of the test composition including effects on body composition, resting energy expenditure (REE), fat oxidation, hunger feelings and satiety hormones.

Design: A randomized, placebo-controlled, double-blind, parallel design. A 6-week weight loss period (2.1 MJ/day) was followed by 18 weeks weight maintenance with test or placebo. Subjects: Fifty overweight women (age: 18-58 years, body mass index (BMI) 25-32 kg/m²).

Measurements: In weeks 1, 7 and 25, a satiety test with questionnaires and blood samples for analysis of satiety hormones. In weeks 2, 8 and 26, REE, body weight and body composition.

Results: During weight maintenance after significant body weight reduction, there was no significant increase in body weight in the test group (1.1±3.4 kg); the placebo group did gain weight (3.0±3.1 kg, P<0.001). Compared to the placebo group, the test group was less hungry 4 hours after test composition consumption in week 25 (P<0.05) and showed increased glucagon like peptide-1 values 180 minutes after test composition consumption (week 25 versus week 1, P<0.05). Measured REE as a function of fat-free mass (FFM) was significantly higher than predicted REE (P<0.05) in week 26 for the test group, but not for the placebo group. Fat mass (FM) was significantly more decreased in the test group (6.5±4.1 kg) compared to the placebo group (4.1±3.6 kg) (week 26 versus week 2, P<0.05).

Conclusion: Consumption of the test composition improved weight maintenance compared to placebo, which can be explained by the relatively higher REE as a function of FFM, relatively higher decrease in FM and the relatively lower increase in hunger.

CLINICAL #2: Short-term effects of yoghurt containing the test composition on energy and macronutrient intakes in non-obese subjects.

Background: The satiating properties of fat remain poorly understood, particularly with reference to its physicochemical characteristics.

Objective: To investigate the short-term effects of consumption of yoghurt containing either the test composition or normal milk fat, on the energy and macronutrient intakes of non-obese subjects.

Design: Two double-blind, placebo-controlled, within-subject crossover studies were conducted three months apart. Twenty-nine (15 female, 14 male) and thirty (16 female, 14 male) subjects participated in Study 1 and Study 2 respectively. In each study, subjects were given in random order, 7 days apart, either a 200 g portion of a test (5 g of the test composition, 1 g milk fat) or control (6 g milk fat) at 13 hours. At 4 hours post-consumption subjects were given ad libitum access to a range of foods. Amounts of food consumed by individuals were determined by pre- and post-covert weighing of individual serving dishes.

Results: Mean energy intakes were significantly lower after the test composition compared with the control in Study 1 (6.4 versus 7.6 MJ; P<0.001), Study 2 (6.9 versus 7.9 MJ; P<0.001), and for both studies combined (6.7 versus 7.7 MJ; P<0.001). The corresponding fat intakes in Study 1, Study 2 and in the combined studies were all significantly reduced (P<0.001). Protein and carbohydrate intakes were also significantly reduced in Study 1 (P<0.05), Study 2 (P<0.01), and for the combined studies (P<0.001).

Conclusions: These results suggest that the physicochemical characteristics of small amounts of dietary fat affect short-term satiety.

CLINICAL #3: The effects of the test composition on energy and macronutrient intakes in non-overweight, overweight and obese subjects.

Objective: To investigate the effects of the test composition on energy and macronutrient intakes up to 8 hours post-consumption in non-overweight, overweight and obese subjects, and to assess energy compensation over the following 24 hours.

Design: A double-blind, placebo-controlled, within-subject crossover design was used. Twenty (10 female, 10 male) non-overweight (body mass index (BMI) 20-24.9 kg/m²), 20 (10 female, 10 male) overweight (BMI 25-29.9 kg/m²), and 20 (13 female, 7 male) obese (BMI>30 kg/m²) subjects participated in the study. Subjects were given in random order, 7 days apart, either a 200 g portion of a test (5 g of the test composition, 1 g milk fat) or control (6 g milk fat) at 9 hours. At 4 and 8 hours post-consumption subjects were given ad libitum access to a range of foods. Amounts of food consumed were determined by pre and post-covert weighing of individual serving dishes. Over the following 24 hours, subjects weighed and recorded all food intakes.

Results: Mean energy intakes were significantly lower after the test composition compared with the control in non-overweight (3.79 versus 5.43 MJ; P<0.01) and overweight (4.43 versus 6.12 MJ; P<0.001) subjects 4 hours post-consumption and in non-overweight (3.82 versus 5.38 MJ; P<0.001), overweight (3.94 versus 5.80 MJ; P<0.001) and obese (4.91 versus 6.26 MJ; P<0.01) subjects 8 hours post-consumption. The corresponding macronutrient intakes were also significantly reduced in non-overweight and overweight subjects (P<0.01) at 4 hours post-consumption and in all subjects 8 hours post-consumption (P<0.01). In the total group, energy intakes over the following 24 hours were also significantly reduced (6.35 versus 7.70 MJ; P<0.01) after the test composition relative to the control.

Conclusions: These results suggest that the effects of the test composition are maintained at least up to 8 hours and are evident in non-overweight, overweight and obese subjects.

CLINICAL #4: Dose-response effects of the test composition.

Objective: To investigate the dose-response effects of the test composition on energy and macronutrient intakes up to 36 hours post-consumption in non-overweight subjects.

Design: A single-blind, placebo-controlled, within-subject cross-over design was used.

Subjects: Fifty subjects (30 female, 20 male).

Interventions: Subjects were given in random order, 7 days apart, a 200 g portion of the test composition containing a total of 15 g of fat, which varied in quantity of test composition (0, 2, 4, 6 g) at 9 hours. At 13 hours subjects were given ad libitum access to a range of foods. Amounts of food consumed were measured by covert pre- and post-consumption weighing of individual serving dishes. For the remainder of the day and the following 24 hours, subjects weighed and recorded all food intakes.

Results: Relative to the control, mean energy (7.42 versus 5.83, 5.60, 5.24 MJ), fat (97.4 versus 74.4, 74.2, 67.5 g; 48.8 versus 46.8, 48.9, 47.6% energy), protein (59.1 versus 50.0, 44.0, 40.8 g; 13.2 versus 13.9, 12.9, 12.8% energy), and carbohydrate (171.5 versus 140.9, 130.2, 126.0 g; 38:0 versus 39.3, 38.2, 39.6% energy), intakes were progressively reduced with increasing doses of the novel fat emulsion in the total group (P<0.001). A similar response was observed in the female group up to 4 g (P<0.001) and in the male group after 2 and 6 g (P<0.05). Energy and macronutrient intakes for the remainder of each study day and over the following 24 hours were significantly lower after all dose levels compared to the control (P<0.001).

Conclusion: The results suggest that the test composition reduced the effect of overeating during an ad libitum lunch meal and subsequent food intake up to 36 hours post-consumption.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A composition for suppressing a mammal's appetite, comprising:
a fatty acid complex comprised of fatty acids comprising carbon chain lengths of 12 to 22; and
a sweetener.

2. The composition of claim 1, wherein the fatty acid complex comprises at least two fatty acids selected from the group consisting of: alpha-linoleic acid, arachidic acid, behenic acid, capric acid, caprylic acid, eicosanic acid, erucic acid, lauric acid, linoleic acid, margaric acid, margaroleic acid, myristic acid, palmitic acid, palmitoleic acid, and stearic acid.

3. The composition of claim 1, wherein the fatty acid complex comprises lauric acid, linoleic acid, and oleic acid.

4. The composition of claim 3, wherein the fatty acid complex further comprises palmitoleic acid.

5. The composition of claim 1, wherein the sweetener comprises a non-caloric sweetener.

6. The composition of claim 5, wherein the non-caloric sweetener comprises at least one sweetener selected from the group consisting of: acesulfame potassium, stevia, lo han quo (Mormodica grosvenorii), mabinlang (Capparis masaikai), sucralose, thaumatin (Thaumatococcus daniellii), and brazzein (Pentadiplandra brazzana).

7. The composition of claim 5, wherein the sweetener is mixed with a bulking agent.

8. The composition of claim 7, wherein the bulking agent is selected from the group consisting of erythritol, gluco-mannitol, and gluco-sorbitol.

9. The composition of claim 1, wherein the fatty acid complex comprises linoleic acid, oleic acid, and MCT oil.

10. The composition of claim 1, further comprising an extract of ashwagandha (Withania somnifera).

11. The composition of claim 1, wherein the composition further comprises a mixture of a linear aminopolysaccharide and lipoprotein lipase.

12. The composition of claim 11, wherein the linear aminopolysaccharide comprises recurring units of (1-4)-linked 2-amino-2-deoxy-β-D-glucopyranose.

13. The composition of claim 11, wherein the composition further comprises at least one ingredient selected from the group consisting of:
citric acid;
calcium polyascorbate;
2-hydroxy-1,2,3-propanetricarboxylic acid; and
lovastatin.

14. The composition of claim 1, wherein the fatty acid complex comprises myristic acid, lauric acid, linolenic acid, and palmitic acid.

15. The composition of claim 14, wherein the composition further comprises an extract of Irvingia gabonensis as a source of myristic acid, lauric acid, linolenic acid, and palmitic acid.

16. The composition of claim 1, wherein the composition comprises a linear aminopolysaccharide.

17. The composition of claim 1, wherein the composition further comprises a fruit juice concentrate, water, xanthan gum, soy lecithin, sodium benzoate, potassium sorbate, a flavoring agent, sucralose, and citric acid.

18. A composition for suppressing a mammal's appetite and reducing blood serum levels of low-density lipoproteins and triglycerides comprising:
a fatty acid complex;
an aminopolysaccharide; and
a sweetener.

19. A method of suppressing a mammal's appetite comprising the steps of:
(a) preparing a composition comprising a fatty acid complex comprised of fatty acids comprising carbon chain lengths of 12 to 22 and a sweetener; and
(b) permitting a mammal to ingest the composition at regular intervals.

20. A method of affecting changes in blood serum levels of low-density lipoproteins, triglycerides, and high-density lipoproteins comprising the steps of:
(a) preparing a composition comprising a fatty acid complex comprised of fatty acids comprising carbon chain lengths of 12 to 22, a sweetener, and a mixture of linear aminopolysaccharide and lipoprotein lipase; and
(b) permitting a mammal to ingest the composition at regular intervals.
